(19) United States
(12) Patent Application Publication
(10) Pub. No.: US 2014/0103002 A1
(43) Pub. Date: Apr. 17, 2014

(54) COLLAPSIBLE RECEPTACLE AND METHODS THEREOF

(71) Applicant: Roy Huemer, Freehold, NJ (US)

(72) Inventor: Roy Huemer, Freehold, NJ (US)

(21) Appl. No.: 14/054,475

(22) Filed: Oct. 15, 2013

Related U.S. Application Data
(60) Provisional application No. 61/714,013, filed on Oct. 15, 2012.

(51) Int. Cl. B65F 1/14

(52) U.S. Cl. CPC B65F 1/1415
USPC 211/195; 29/525.01

(57) ABSTRACT

A collapsible receptacle is provided that may comprise a plurality of vertical supports; a straight coupler adapted to couple at least two of the plurality of vertical supports; a plurality of horizontal supports; an angled coupler adapted to couple at least one of the plurality of vertical supports to one of the plurality of horizontal supports; and a joining member adapted to maintain a connection of the plurality of vertical supports and the plurality of horizontal supports.

### CROSS-REFERENCE TO RELATED APPLICATIONS

The present application claims priority to U.S. Provisional Patent Application Ser. No. 61/714,013 entitled “COLLAPSIBLE RECEPTACLE AND METHODS THEREOF,” filed Oct. 15, 2012, the disclosure of which is incorporated herein by reference in its entirety.

### BACKGROUND

1. Field of the Invention

Embodiments of the present disclosure generally relate to a collapsible receptacle. More specifically, embodiments of the present disclosure relate to a collapsible receptacle for refuse that may comprise a plurality of supports, support couplers, and a joining member.

2. Description of Related Art

Business that provide food service at remote locations, such as catering companies, often transport large items, such as tables, chairs, dance floors, refuse receptacles, and the like, to events. To transport these large items, catering companies use trucks and similar vehicles with limited storage capacities. The size of the event that can be catered by a particular company may be limited to the size of the storage areas of the caterer's vehicles. Transporting these large items can be time-consuming and cumbersome. Carrying large refuse receptacles, for example, may require two or more people and may place the carriers at risk of injury due to the weight of the receptacles.

In view of the limited storage capacity of the caterer's vehicles, many caterers desire to use furniture items that take up the least amount of storage space, allowing these caterers to offer services for larger events. For example, folding chairs and tables may be used instead of tables that are fixed in an un-foldable state and that cannot be easily stored and transported. Refuse receptacles, however, must be carried in the fully-assembled state and cannot be broken down for easier transportation and storage.

Thus, a need exists for a collapsible receptacle for refuse that may be easily transported and stored.

### SUMMARY

Embodiments of the present invention generally relate to a collapsible receptacle that may comprise a plurality of vertical supports; a straight coupler adapted to couple at least two of the plurality of vertical supports; a plurality of horizontal supports; an angled coupler adapted to couple at least one of the plurality of vertical supports to one of the plurality of horizontal supports; and a joining member adapted to maintain a connection of the plurality of vertical supports and the plurality of horizontal supports.

In another embodiment of the present disclosure, a collapsible receptacle may comprise a plurality of vertical supports; at least two top supports; at least two bottom supports; a straight coupler adapted to couple at least two of the plurality of vertical supports; at least one top angled coupler adapted to couple at least one of the plurality of vertical supports to at least one of the top supports; at least one bottom angled coupler adapted to couple at least one of the plurality of vertical supports to at least one of the top supports; and a joining member adapted to maintain a connection of each of the top supports, the bottom supports, and the vertical supports.

In yet another embodiment of the present disclosure, a method for assembling a collapsible receptacle may comprise providing a collapsible receptacle comprising: a plurality of vertical supports; a plurality of straight couplers adapted to couple at least two of the plurality of vertical supports; a plurality of horizontal supports; a plurality of angled couplers adapted to couple at least one of the plurality of vertical supports to one of the plurality of horizontal supports; and a joining member adapted to maintain a connection of the plurality of vertical supports and the plurality of horizontal supports, the joining member running through each of the plurality of vertical supports and each of the plurality of horizontal supports; connecting each of the plurality of vertical supports into pairs of two with at least one of the plurality of straight couplers; and connecting a first unconnected side of each of the vertical supports to at least one horizontal support with at least one of the plurality of angled couplers.

### BRIEF DESCRIPTION OF THE DRAWINGS

So the manner in which the above recited features of the present disclosure can be understood in detail, a more particular description of embodiments of the present disclosure, briefly summarized above, may be had by reference to embodiments, which are illustrated in the appended drawings. It is to be noted, however, the appended drawings illustrate only typical embodiments of embodiments encompassed within the scope of the present disclosure, and, therefore, are not to be considered limiting, for the present disclosure may admit to other equally effective embodiments, wherein:

FIG. 1 depicts a front perspective view of a collapsible receptacle in an assembled configuration in accordance with embodiments of the present disclosure;

FIG. 2 depicts a side perspective view of a collapsible receptacle in an assembled configuration in accordance with embodiments of the present disclosure;

FIG. 3 depicts a perspective view of a portion of a collapsible receptacle in accordance with embodiments of the present disclosure;

FIG. 4A depicts a perspective view of a portion of a collapsible receptacle in accordance with embodiments of the present disclosure;

FIG. 4B depicts a perspective view of a portion of a collapsible receptacle in accordance with embodiments of the present disclosure;

FIG. 5 depicts a top cross-sectional view of a portion of a collapsible receptacle in accordance with embodiments of the present disclosure;

FIG. 6A depicts a perspective view of a portion of a collapsible receptacle in accordance with embodiments of the present disclosure;

FIG. 6B depicts a perspective view of a portion of a collapsible receptacle in accordance with embodiments of the present disclosure;

FIG. 7 depicts a side perspective view of a collapsible receptacle in a disassembled configuration in accordance with embodiments of the present disclosure;

FIG. 8 depicts a top view of a joining member in accordance with embodiments of the present disclosure; and

FIG. 9 depicts a flowchart of a method of using a collapsible receptacle in accordance with embodiments of the present disclosure.

The headings used herein are for organizational purposes only and are not meant to be used to limit the scope of the description or the claims. As used throughout this application, the words “may” and “can” are used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present disclosure generally relate to a collapsible receptacle. More specifically, embodiments of the present disclosure relate to a collapsible receptacle for refuse that may comprise a plurality of supports, support couplers, and a joining member. As used herein, the term “refuse” is intended to include material to be discarded and/or recycled, including, but not limited to debris, junk, rubbish, recyclables, trash, waste, and/or the like.

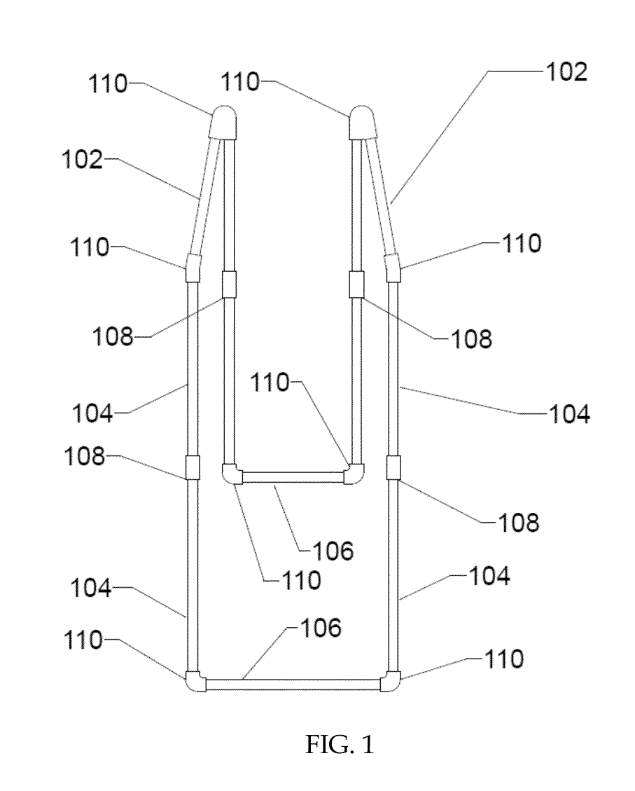

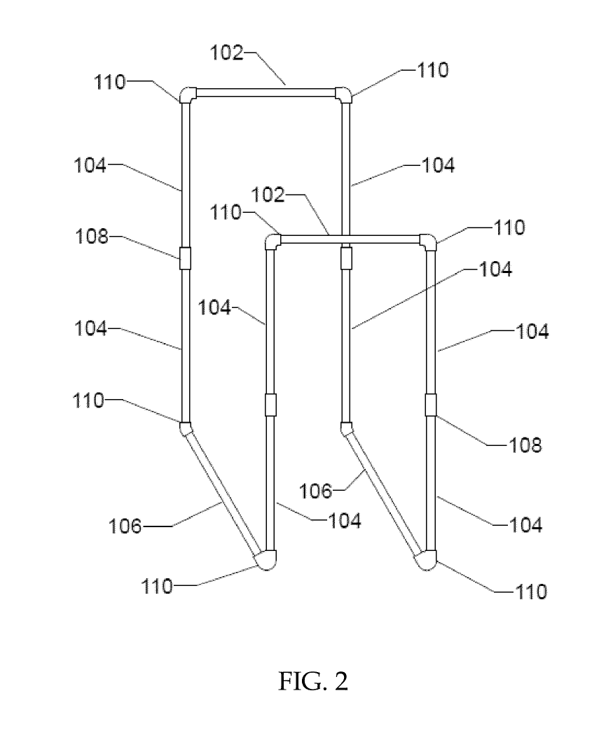

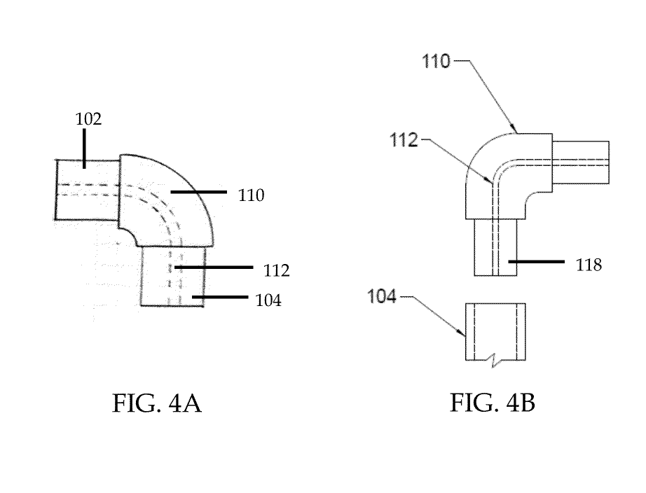

FIGS. 1 and 2 depict views of a collapsible receptacle 100 in an assembled configuration in accordance with embodiments of the present disclosure. In exemplary embodiments, a collapsible receptacle 100 may generally comprise top supports 102, side supports 104, bottom supports 106, couplers 108, 110, and a joining member (not shown). A receptacle 100 in accordance with embodiments of the present invention may comprise vertical supports, for example, the side supports 104. A receptacle 100 may also comprise horizontal supports, for example, the top supports 102 and the bottom supports 106. The couplers 108, 110 may be adapted to couple the supports 102, 104, 106 and may comprise straight couplers 108 and/or angled couplers 110. The receptacle 100 may be assembled by coupling the supports 102, 104, 106 together with the couplers 108, 110. The receptacle 100 may be disassembled by decoupling the supports 102, 104, 106 from the couplers 108, 110 and folding the supports 102, 104, 106 in a substantially collapsed/bundled configuration (see FIG. 4). In the assembled state, the receptacle 100 may be formed in two generally u-shaped groups of supports formed by bottom supports 106, side supports 104, and couplers 108, 110, and the two generally u-shaped groups of supports may be coupled together by the top supports 102. When fully assembled, the receptacle 100 may stand vertically from a floor and/or ground surface with the bottom supports 106 disposed at the bottom and the top supports 102 disposed at the top. When flipped completely over, the receptacle 100 may retain the same functionality, with the top supports 102 disposed at the bottom and the bottom supports 106 disposed at the top of the receptacle 100. For ease, only two side supports 104 and angled couplers 110 are labeled in FIGS. 1-2 and only one straight coupler 108 is labeled. This is merely for ease, however, as any number of side supports 104, angled couplers 110 and straight couplers 108 consistent with embodiments of the present disclosure may be used. For example, as can be seen in FIG. 1, the receptacle 100 may comprise eight or more side supports 104, four or more straight couplers 108, and/or eight or more angled connectors 110, or the like.

In an assembled state, the collapsible receptacle 100 may be adapted to support a refuse collector such as a standard trash bag or the like. Portions of the top of a trash bag may fit over the top supports 102 so that the trash bag hangs downward toward the floor between the bottom supports 106 and the opening of the trash bag is disposed between the top supports 102. In some embodiments, a decorative cover may be placed around the exterior of the receptacle to hide the trash bag and improve the aesthetic appearance of the receptacle 100. When the trash bag is full, the bag may be removed and a second trash bag may be placed in the same location as the first trash bag over the top supports 102. When the receptacle 100 is no longer in use and no longer needed in a specific location, the receptacle 100 may be disassembled and placed in the collapsed/bundled configuration for ease of storage and/or transportation. Because the receptacle 100 is collapsible, it may be especially useful to catering businesses that need to transport refuse receptacles from location to location. When the receptacle 100 is in a collapsed/bundled configuration (see FIG. 4), it may easily be stored in a bin and/or placed in a vehicle for transportation to a new location.

In exemplary embodiments, the receptacle 100 may be stand-alone or may be adapted to fit on a slidable track, so that the receptacle 100 may slide under a surface to be hidden from view when not in use, and may slide out for accessibility when needed. For example, the receptacle 100 may be slid on a track under a counter or table top when not in use, and be slid out from under the counter or table top when needed. The general “u” shape of the receptacle 100 may allow a user to change a trash bag without having to lift the trash bag up and over the top supports 102. In exemplary embodiments, the trash bag may be removed from the top supports 102 and pulled through the side between the side supports 104 without having to be pulled over the top supports 102.

In exemplary embodiments, the supports 102, 104, 106 may be adapted to support the weight of a full refuse collector, such as a trash bag. The supports 102, 104, 106 may be adjustable or may be of a fixed length. In some embodiments, the supports 102, 104 may be telescoping. The top supports 102, side supports 104, and bottom supports 106 may all comprise the same length, or may comprise different lengths. The receptacle 100 may be height and/or width adjustable to adapt to different refuse collectors. For example, the supports 102, 104, 106 may comprise two or more telescoping pieces. The supports 102, 104, 106 and/or the couplers 108, 110 may comprise any material adapted to support the weight of a full refuse collector. For example, the supports 102, 104, 106 and/or the couplers 108, 110 may comprise PVC, plastic, wood, metal, and/or the like. The supports 102, 104, 106 and/or the couplers 108, 110 may comprise a substantially hollow material and/or a solid material. For example, the supports 102, 104, 106 may comprise hollow PVC pipes.

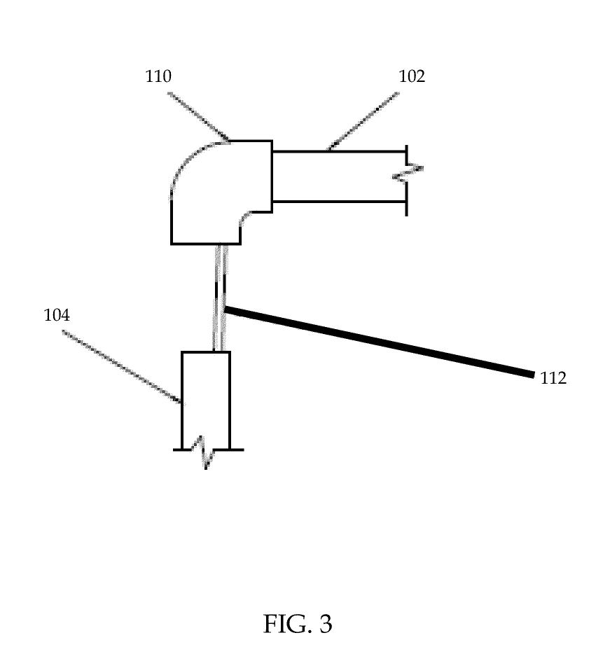

The couplers 108, 110, may comprise a material adapted to couple two supports 102, 104, 106 together. By way of example, the couplers 108, 110 may comprise PVC, plastic, wood, metal, and/or the like. The straight couplers 108 may be adapted to join two supports 102, 104, 106 in a substantially linear configuration such that the two supports are in a substantially linear relationship. For example, the straight couplers 108 may comprise PVC slip couplings. In exemplary embodiments, the straight couplers 108 may be adapted to couple two or more side supports 104 to increase the height of the receptacle 100. The straight couplers 108 may also be used to join top supports 102 and/or bottom supports 106 to increase the width of the receptacle 100. The angled couplers 110 may be adapted to join two supports in an angled configuration such that the two supports are not in a substantially liner relationship. For example, the angle couplers 110 may comprise PVC elbow joints. The angled couplers 110 may generally be adapted to couple supports 102, 104, 106 at any angle in a range greater than 0 degrees and less than 180 degrees. In order to avoid losing any of the parts of the receptacle 100, the receptacle 100 may comprise a joining member for keeping the pieces of the receptacle 100 together when it is in a collapsed/bundled configuration. The joining member may also add strength to the receptacle 100 when the receptacle 100 is in an assembled configuration, thereby increasing the support for the refuse collector. An exemplary joining member is depicted in FIG. 3. Alternative couplers 108, 110, for example, couplers that fit within the supports and join the supports together and form substantially seamless connections between the supports, are also contemplated by and within embodiments of the present invention.

Referring now to FIG. 3, a perspective view of a portion of a receptacle 100 in accordance with embodiments of the present disclosure is depicted. The portion of the receptacle 100 includes a top support 102, an angled coupler 110, a side support 104, and a joining member 112. Although depicted as extending between an angled coupler 110 and a side support 104, it is contemplated that the joining member 112 may extend through the entire receptacle 100 between hollow centers of the supports 102, 104, 106 and the couplers 108, 110. The joining member 112 may alternatively only partially extend through the receptacle 100. The joining member 112 may comprise a material adapted to provide securing tension to secure the connections between the supports 102, 104, 106 and the couplers 108, 110. For example, the joining member 112 may comprise an elastic cord such as a bungee cord. In some embodiments, the joining member 112 may be inelastic and may comprise a rope, a string, a chain, and/or the like. The joining member 112 may form a single contiguous piece or may form a piece with two ends tied together and/or attached together. In further embodiments, the joining member 112 may comprise a set of pined joints, such that the entire apparatus may collapse about its joints without complete separation therefrom. The joining member 112 may also comprise ends that are attached to a portion of the receptacle 100.

When in an assembled state, the receptacle 100 may be held together by both the couplers 108, 110 and the tension in the joining member 112 running through a hollow center of the supports 102, 104, 106 and the couplers 108, 110. When in a disassembled state, the supports 102, 104, 106 and the couplers 108, 110 may be held together only by the joining member 112 because the couplers 108, 110 and the supports are decoupled when the receptacle 100 is in a disassembled state. By keeping the supports 102, 104, 106 and the couplers 108, 110 together when the receptacle 100 is in a disassembled state, the joining member 112 may prevent the loss of the parts. In addition to keeping the supports 102, 104, 106 and couplers 108, 110 together when the receptacle 100 is in a disassembled state, it also may be desired to keep the supports 102, 104, 106 and couplers 108, 110 in a bunched and/or collapsed configuration for transportation and/or storage.

Referring now to FIG. 4A, a perspective view of a portion of a collapsible receptacle 100 in accordance with embodiments of the present disclosure is depicted. The portion of the receptacle 100 includes a top support 102, an angled coupler 110, a side support 104, and a joining member 112. The joining member 112 is depicted in phantom to illustrate that the joining member 112 may be disposed within an interior cavity, channel, void, or the like, within the top support 102, coupler 110, and side support 104. Although depicted as extending between an angled coupler 110 and a side support 104, it is contemplated that the joining member 112 may extend through the entire receptacle 100 between centers of the supports 102, 104, 106 and the couplers 108, 110. In some embodiments, the joining member 112 may not be included. The receptacle 100 may be assembled by frictionally fitting the support components together. For example, the top support 102 may be frictionally fit within an opening in the coupler 110 and the side support 104 may be frictionally fit into an opening in an opposing end of the coupler 110.

In some embodiments, the joining member 112 may alternatively only partially extend through the receptacle 100. A joining member 112 may be attached to a portion of the receptacle 100. For example, the joining member may be fastened or attached with fastening means, such as rivets, and/or detachably attached to the top support 102 on one end and to the side support 104 on another end. In some embodiments, portions of the receptacle 100, such as the supports 102, 104, 106 and the couplers 108, 110 may be frictionally secured to each other.

In some embodiments, portions of the receptacle 100, such as the supports 102, 104, 106 and the couplers 108, 110 may be secured to each other with snap connectors, screw connectors, hinged joints, and/or the like. For example, the top support 102 may comprise an end having a threaded exterior surface, such as a helical ridge for screwing into an internal complimentary thread within the coupler 110. In another example, an end of the top support 102 may comprise a portion adapted to snap within the coupler 110 when the support 102 is inserted into the coupler at past a predetermined distance, and may be uncoupled by releasing the snap.

Alternative coupling means for coupling the components of the receptacle 100, consistent with the present disclosure, are contemplated and may be used. In some embodiments, the supports 102, 104 may comprise curved ends and the coupler 110 may comprise a curved plug adapted to frictionally fit within abutting ends of supports 102, 104, thereby creating a substantially seamless connection with little or no protrusions from the surface of the receptacle 100.

Referring now to FIG. 4B, a perspective view of a portion of the collapsible receptacle 100 in accordance with embodiments of the present disclosure is depicted. The portion of the receptacle 100 includes an angled coupler 110, a side support 104, and a joining member 112, and a plug member 118. The joining member 112 is depicted in phantom to illustrate that the joining member 112 may be disposed within an interior cavity, channel, void, or the like, within the coupler 110, the plug 118, and the side support 104. Although depicted as extending between an angled coupler 110 and a side support 104, it is contemplated that the joining member 112 may extend through the entire receptacle 100 between centers of the supports 102, 104, 106 and the couplers 108, 110. In exemplary embodiments, the plug 118 may be adapted to frictionally and/or securely fit within a cavity in the side support 104, the coupler 110, and/or the like, thereby creating a more seamless appearance when the coupler 110 is joined with the side support 104, or the like.

In exemplary embodiments, a plug 118 may be used to join any two supports, couplers and/or the like in accordance with embodiments of the present invention. In some embodiments, the plug 118 may be a separate piece from the supports and/or the couplers. In other embodiments, the plug 118 may be integral with a support and/or the coupler on one side, allowing the other side to couple with an opening in an opposing support and/or coupler. In some embodiments, the channel, opening, or the like, within the supports and/or the couplers may comprise a wide opening nearly as large as the exterior surface of the supports and/or the couplers. In some embodiments, the channel, opening, or the like, within the supports and/or the couplers may be narrower, for example, a substantially narrow channel slightly larger in diameter than the joining member 112, or the like. In some embodiments, any of the supports and/or the couplers may comprise a plug 118, or the like. In some embodiments, the channel may be centered within the supports and/or couplers, or may be disposed off-center.

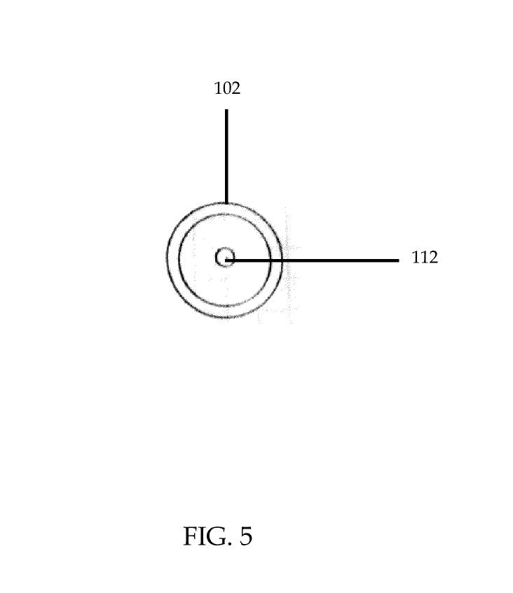

Referring now FIG. 5, a top cross-sectional view of a portion of a collapsible receptacle 100 in accordance with embodiments of the present disclosure is depicted. In exemplary embodiments, the receptacle 100 may comprise a support 102 and/or a joining member 112. A joining member 112 may be disposed within an interior portion of a support 102, or the like. Although depicted as substantially larger than the joining member 112, the diameter of the opening within a support 102, or the like, may be incrementally larger than the diameter of the joining member 112, such that movement of the joining member 112 may be restricted.

In some embodiments, a portion of the joining member 112 may be attached to a surface of an interior opening of the support 102. In some embodiments, the joining member 112 may pass through the center of the support 102. In some embodiments, the joining member 112 may pass through an off-center portion of the support 102. Although one joining member 112 is depicted, any number of joining members consistent with the present disclosure is contemplated. For example, zero, two, three, or four joining members 112 may be used. In some embodiments, different numbers of joining members 112 may be used to secure different sections of the receptacle 100, or the same number of joining members 112 may be used. In some exemplary embodiments, the joining member 112 may comprise a single contiguous piece, or the like.

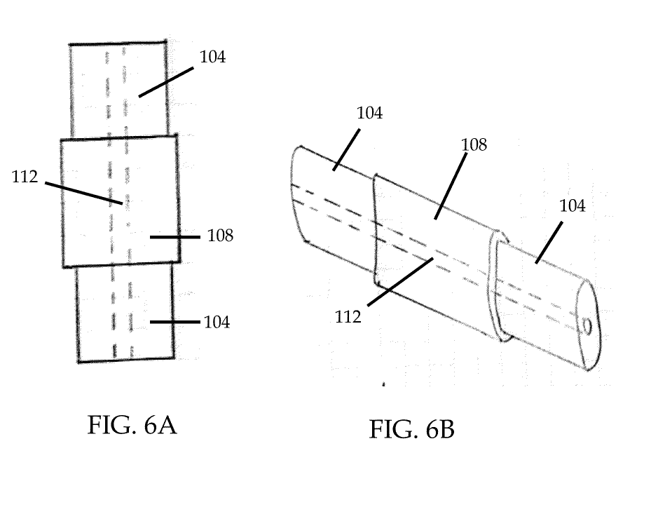

Referring now to FIGS. 6A and 6B, views of a portion of a collapsible receptacle 100 in accordance with embodiments of the present disclosure are depicted. The portion of the receptacle 100 includes side supports 104, a coupler 108, and a joining member 112. The joining member 112 is depicted in phantom to illustrate that the joining member 112 may be disposed within an interior cavity, channel, void, or the like, within the supports 104 and the coupler 108, and side support 104. Although depicted as extending between side supports 104 and a coupler 108, it is contemplated that the joining member 112 may extend through the entire receptacle 100 between centers of the supports 102, 104, 106 and the couplers 108, 110. The receptacle 100 may be assembled by frictionally fitting the support components together. For example, the side supports 104 may be frictionally fit within an opening in the coupler 108 and the side support 104 may be frictionally fit into an opening in an opposing end of the coupler 108.

In some embodiments, the joining member 112 may alternatively only partially extend through the receptacle 100. A joining member 112 may be attached to a portion of the receptacle 100. For example, the joining member may be fastened or attached with fastening means, such as rivets, and/or detachably attached to one support 104 on one end and a second support 104 on another end. In some embodiments, portions of the receptacle 100, such as the supports 102, 104, 106 and the couplers 108, 110 may be frictionally secured to each other.

In some embodiments, portions of the receptacle 100, a side support 104 may comprise an end having a threaded exterior surface, such as a helical ridge for screwing into an internal complimentary thread within the coupler 108. In another example, an end of a support 104 may comprise a portion adapted to snap within the coupler 108 when the support 102 is inserted into the coupler at past a predetermined distance, and may be uncoupled by releasing the snap.

Alternative coupling means for coupling the components of the receptacle 100, consistent with the present disclosure, are contemplated and may be used. In some embodiments, the coupler 108 may comprise a plug adapted to frictionally fit within abutting ends of supports 104, thereby creating a substantially seamless connection with little or no protrusions from the surface of the receptacle 100. In some embodiments, a locking means may be included to lock the supports 102, 104 together.

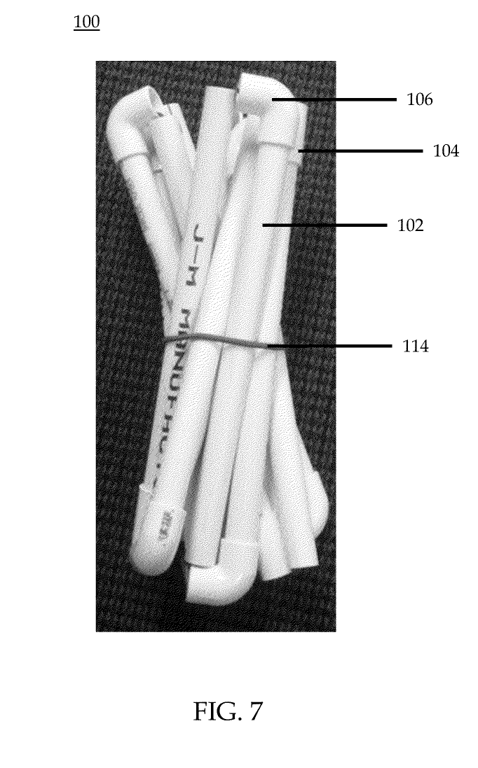

FIG. 7 depicts a side perspective view of a collapsible receptacle 100 in a disassembled and bunched configuration in accordance with embodiments of the present disclosure. In exemplary embodiments, when in a bunched configuration, the supports 102, 104, 106 may be bunched in a group and substantially adjacent other supports 102, 104, 106. When the receptacle 100 is in a bunched configuration, it may be easier to transport the receptacle 100. In order to maintain the receptacle in a disassembled and bunched configuration as show in FIG. 7, a bunching member 114, or the like, may be used.

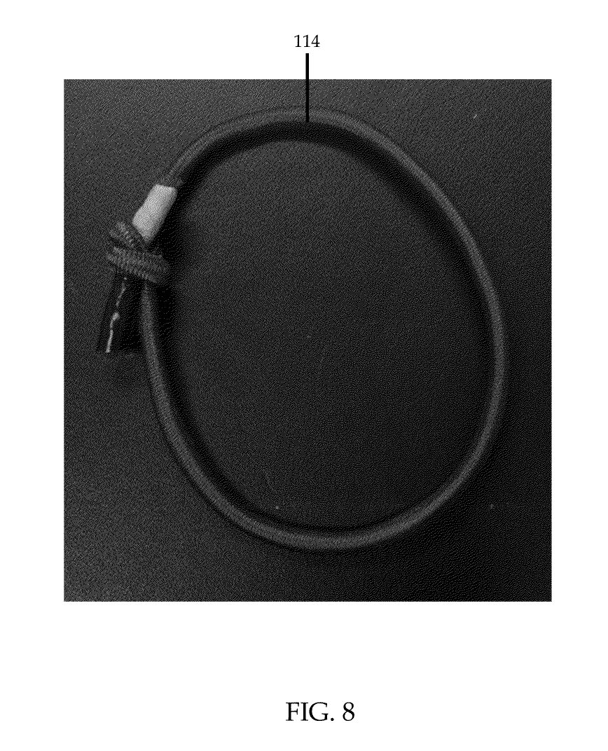

FIG. 8 depicts a bunching member 114 in accordance with embodiments of the present disclosure. In exemplary embodiments, the bunching member 114 may comprise a material adapted to secure the receptacle 100 in a bunched configuration. For example, the bunching member 114 may comprise an elastic cable, such as a bungee cable, or may comprise an inelastic cable, such as a rope or string. The bunching member 114 may comprise a single contiguous piece or may comprise a piece with two ends tied together and/or attached together. The bunching member 114 may also comprise ends that are attached to a portion of the receptacle 100. The bunching member 114 may keep the receptacle 100 in a bunched configuration wherein the supports 102, 104, 106 are bunched together and substantially adjacent each other. When the receptacle 100 is in a bunched configuration, it may be easier to transport. Because the receptacle 100 is easy to transport, the receptacle 100 may be especially attractive to catering companies that need to transport receptacles from location to location and place a high value on storage space in their vehicles.

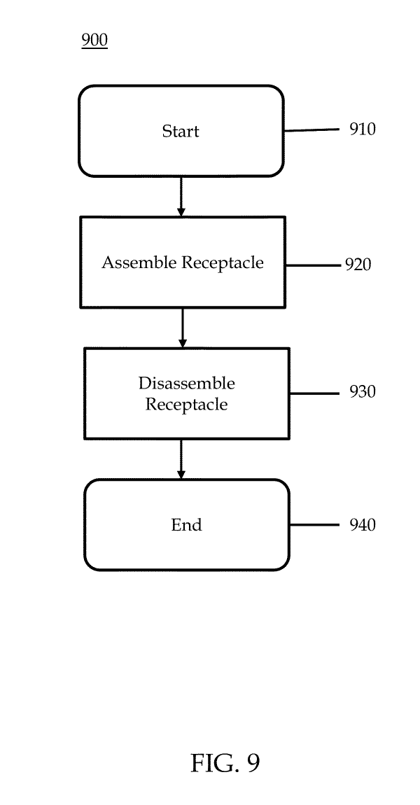

FIG. 9 depicts a flowchart of a method of using a collapsible receptacle in accordance with embodiments of the present disclosure. In accordance with embodiments of the present disclosure, a collapsible receptacle, such as the examples disclosed herein with respect to FIGS. 1-8 is provided for use at step 910, where the method may begin. In embodiments, such a collapsible receptacle may generally comprise a plurality of supports, support couplers, a joining member, and a bunching member. For convenience, the method 900 of FIG. 9 is described with reference to the collapsible receptacle 100 described hereinabove with respect to FIGS. 1-8. The method 900 may be carried out using other embodiments as well.

At step 920, the receptacle 100 may be assembled. To begin assembling the receptacle, the bunching member 114 may be removed and the supports 102, 104, 106 may be unbunched. The supports 102, 104, 106 may then be joined together with the couplers 108, 110. For example, the bottom supports 106 may be joined to a side support 104 on opposite ends via angled couplers 110. The side supports 104 may be joined with additional side supports 104 via a straight coupler 108. A number of the additional side supports 104 may be joined together with top supports 102 via additional angled couplers 110. For example, the top supports 102 may be joined together in two pairs. When the supports 102, 104, 106 are attached via couplers 108, 110, such that the receptacle 100 forms two substantially upward u-shaped members joined together at a top portion with the top supports 102 and angled couplers 110, the receptacle 100 is assembled. A refuse collector, such as a trash bag, may be secured to the top supports 102 by spreading the trash bag opening and securing the opening around the top supports 102 and the angled couplers 110 coupling the top supports 102, and allowing the bottom of the trash bag to extend downward toward the ground surface between the bottom supports 106. After the trash bag is installed, the receptacle 100 is ready for use. When a trash bag change is needed, the trash bag may be removed from the top supports 102 and the angled couplers 110 coupling the top supports, and removed out the side of the receptacle 100 through the u-shaped opening between the side supports 104 and the bottom supports 106. After the receptacle 100 is no longer needed, the receptacle 100 may be disassembled at step 930.

At step 930, the receptacle 100 may be disassembled by decoupling all of the supports 102, 104, 106 and grouping them in a collapsed and/or bunched configuration. When the receptacle 100 is in a collapsed and/or bunched configuration with the supports 102, 104, 106 substantially adjacent each other, a bunching member 114 may be placed around the bunch so that the supports 102, 104, 106 are secured in the bunched configuration. After the receptacle 100 is secured in a bunched configuration with the bunching member 114, the receptacle 100 is ready for storage and/or transportation and the method may end at step 940.

It should be emphasized that the above-described embodiments of the present disclosure are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

Now that exemplary embodiments of the present disclosure have been shown and described in detail, various modifications and improvements thereon will become readily apparent to those skilled in the art.

It will be understood that one or more of the steps described can be rearranged, separated, and/or combined without deviating from the scope of embodiments of the disclosure. For ease, steps are, at times, presented sequentially. This is merely for ease and is in no way meant to be a limitation.

Further, it will be understood that one or more of the elements and/or exemplary embodiments of the disclosure described can be rearranged, separated, and/or combined without deviated from the scope of the disclosure. For ease, various elements are described, at times, separately. This is merely for ease and is in no way meant to be a limitation.

While the various steps, elements, and/or exemplary embodiments of the disclosure have been outlined above, it is evident that many alternatives, modifications and variations will be apparent to those skilled in the art. The various steps, elements, and/or exemplary embodiments of the disclosure, as set forth above, are intended to be illustrative, not limiting. Various changes can be made without departing from the spirit and scope of the disclosure. Accordingly, the spirit and scope of the present disclosure is to be construed broadly and not limited by the foregoing specification.

No element, act, or instruction used in the description of the present application should be construed as critical or essential to the disclosure unless explicitly described as such. Also, as used herein, the article “a” is intended to include one or more items. Where only one item is intended, the term “one” or similar language is used.

What is claimed is:

1. A collapsible receptacle comprising:
a plurality of vertical supports;
a straight coupler adapted to couple at least two of the plurality of vertical supports;
a plurality of horizontal supports;
an angled coupler adapted to couple at least one of the plurality of vertical supports to one of the plurality of horizontal supports; and
a joining member adapted to maintain a connection of the plurality of vertical supports and the plurality of horizontal supports.

2. The collapsible receptacle of claim 1, wherein the plurality of horizontal supports comprises two top supports and two bottom supports.

3. The collapsible receptacle of claim 2, wherein each of the two top supports comprise opposing ends, each of the opposing ends adapted to attach to a vertical support with the angled coupler.

4. The collapsible receptacle of claim 2, wherein each of the two bottom supports comprise opposing ends, each of the opposing ends adapted to attach to a vertical support with the angled coupler.

5. The collapsible receptacle of claim 1, wherein the plurality of vertical supports comprises eight vertical supports.

6. The collapsible receptacle of claim 1, wherein each of the plurality of vertical supports comprises a pair opposing ends including a first end coupled with a horizontal support with the angled coupler, and a second end coupled with a second vertical support with the straight coupler.

7. The collapsible receptacle of claim 1, wherein the receptacle is adapted to be disassembled by decoupling the angled coupler and the straight coupler, thereby allowing the receptacle to be placed in a bunched configuration.

8. The collapsible receptacle of claim 1, wherein when the receptacle is in an assembled state, the receptacle forms two generally u-shaped groups of supports coupled with top supports.

9. The collapsible receptacle of claim 1, wherein each of the plurality of vertical supports and each of the plurality of horizontal supports comprises a PVC pipe.

10. The collapsible receptacle of claim 2, wherein the joining member comprises an elastic cord.

11. The collapsible receptacle of claim 1, wherein the angled coupler and the straight coupler comprise an opening adapted to receive at least one of a vertical support and a horizontal support.

12. The collapsible receptacle of claim 1, wherein the straight coupler comprises at least one of a plug and a slip coupling; and
wherein the angled coupler comprises at least one of a 90 degree elbow coupling and a 90 degree plug.

13. The collapsible receptacle of claim 1, wherein each of the plurality of vertical supports and each of the plurality of horizontal supports comprises a hollow center adapted to accept the joining member.

14. The collapsible receptacle of claim 1, wherein the joining member runs through the entirety of each of the plurality of vertical supports, each of the plurality of horizontal supports, the straight coupler, and the angled coupler.

15. A collapsible receptacle comprising:
a plurality of vertical supports;
at least two top supports;
at least two bottom supports;
a straight coupler adapted to couple at least two of the plurality of vertical supports;
at least one top angled coupler adapted to couple at least one of the plurality of vertical supports to at least one of the top supports;
at least one bottom angled coupler adapted to couple at least one of the plurality of vertical supports to at least one of the top supports; and
a joining member adapted to maintain a connection of each of the top supports, the bottom supports, and the vertical supports.

16. The collapsible receptacle of claim 16, wherein each of the plurality of vertical supports, each of the at least two top supports, and each of the at least two bottom supports comprises a PVC pipe.

17. The collapsible receptacle of claim 15, wherein the joining member comprises an elastic cord.

18. A method for assembling a collapsible receptacle, the method comprising:
providing a collapsible receptacle comprising:
a plurality of vertical supports;
a plurality of straight couplers adapted to couple at least two of the plurality of vertical supports;
a plurality of horizontal supports;
a plurality of angled couplers adapted to couple at least one of the plurality of vertical supports to one of the plurality of horizontal supports; and
a joining member adapted to maintain a connection of the plurality of vertical supports and the plurality of horizontal supports, the joining member running through each of the plurality of vertical supports and each of the plurality of horizontal supports;
connecting each of the plurality of vertical supports into pairs of two with at least one of the plurality of straight couplers; and
connecting a first unconnected side of each of the vertical supports to at least one horizontal support with at least one of the plurality of angled couplers.

19. The method of claim 18, wherein each of the plurality of vertical supports, each of the plurality of horizontal supports comprises a PVC pipe.

20. The method of claim 18, wherein the joining member comprises an elastic cord.
